(19) United States
(12) Patent Application Publication
(10) Pub. No.: US 2017/0068508 A1
(43) Pub. Date: Mar. 9, 2017

(54) METHOD AND SYSTEM FOR COMMUNICATING WITH A USER IMMERSED IN A VIRTUAL REALITY ENVIRONMENT

(71) Applicant: Nokia Technologies Oy, Espoo (FI)

(72) Inventors: Francesco Cricri, Tampere (FI); Jussi Artturi Leppänen, Tampere (FI); Antti Johannes Eronen, Tampere (FI); Arto Juhani Lehtiniemi, Lempäälä (FI)

(21) Appl. No.: 15/249,664

(22) Filed: Aug. 29, 2016

(30) Foreign Application Priority Data
Sep. 3, 2015 (GB) 1515631.8

(51) Int. Cl. G06F 3/16; G06F 3/0481; G10L 21/003; G06F 3/01

(52) U.S. Cl. CPC G06F 3/165; G06F 3/017; G06F 3/04815; G10L 21/003

(57) ABSTRACT

A method comprising: receiving a request to create a virtual communication channel between the real world and a virtual reality environment, the virtual reality environment comprising both audio and visual content; in response to receiving the request, causing a virtual window to be displayed in the virtual reality environment; and causing distorted audio from real world surroundings of a user making the request to emanate from the virtual window.

### FIELD

The present invention relates to a virtual reality environment, and in particular to a method and system which facilitates an external user to communicate with a user immersed in the virtual reality environment.

### BACKGROUND

Consumer use of virtual reality rendering devices and immersive content such as games and videos is increasing. When consuming virtual reality content, such as a movie, game or OZO content, the user needs to wear a headset or glasses which render the content and headphones to render any audio content. The user is then not well aware of what is happening around them in the real world. This is especially problematic when another person wants the attention of the user consuming the virtual reality content.

### SUMMARY

A first aspect of the invention provides a method comprising:
receiving a request to create a virtual communication channel between the real world and a virtual reality environment, the virtual reality environment comprising both audio and visual content;
in response to receiving the request, causing a virtual window to be displayed in the virtual reality environment; and
causing distorted audio from real world surroundings of a user making the request to emanate from the virtual window.

The method may comprise creating the distorted audio by applying an audio filter which mimics the effect of the audio emanating from behind a physical pane of glass/window. Applying an audio filter may comprise applying a low pass filter and/or applying an impulse response function corresponding to a pane of glass to audio from the real world surroundings of the user making the request.

Receiving a request to create a virtual communication channel may comprise receiving a gestural input signal. The gestural input signal may be received from a depth sensing device monitoring the surroundings of the user making the request. The gestural input signal may comprise a mid-air description of all or part of a quadrilateral.

The method may comprise determining that the gestural input comprises a request to create a window between the real world and the virtual reality environment.

The method may comprise causing the virtual window to appear as a closed window when the virtual window is initially displayed.

The method may comprise receiving a first input at the virtual window from a user immersed in the virtual reality environment and, in response to receiving the first input, causing the virtual window to change from a closed state to an open state.

The method may comprise, in response to receiving the first input at the virtual window, causing un-distorted audio from the real world surroundings of the user making the request to create the virtual communication channel to emanate from the virtual window.

The method may comprise, in response to receiving the first input at the virtual window, causing video images from the real world surroundings of the user making the request to create the virtual communication channel to be displayed in the virtual window.

The method may comprise causing the audio content of the virtual reality environment emanating from the direction of the virtual window to be attenuated when the virtual window is in the open state.

The method may comprise receiving a second input from a user immersed in the virtual reality environment and, in response to receiving the second input, causing the virtual window to be removed from the virtual reality environment.

The user immersed in the virtual reality environment and the user making the request to create a virtual communication channel between the real world and a virtual reality environment may be located in the same physical space.

The user immersed in the virtual reality environment and the user making the request to create a virtual communication channel between the real world and a virtual reality environment may be located in different physical spaces.

A second aspect of the invention provides an apparatus configured to perform a method according to the first aspect.

A third aspect of the invention provides computer-readable instructions which, when executed by computing apparatus, cause the computing apparatus to perform a method according to the first aspect.

A fourth aspect of the invention provides an apparatus comprising:
at least one processor; and
at least one memory including computer program code, which when executed by the at least one processor, cause the apparatus:
   to receive a request to create a virtual communication channel between the real world and a virtual reality environment, the virtual reality environment comprising both audio and visual content;
   in response to receiving the request, to cause a virtual window to be displayed in the virtual reality environment; and
   to cause distorted audio from real world surroundings of a user making the request to emanate from the virtual window.

A fifth aspect of the invention provides an apparatus comprising:
means for receiving a request to create a virtual communication channel between the real world and a virtual reality environment, the virtual reality environment comprising both audio and visual content;
means for, in response to receiving the request, causing a virtual window to be displayed in the virtual reality environment; and
means for causing distorted audio from real world surroundings of a user making the request to emanate from the virtual window.

A sixth aspect of the invention provides a computer-readable medium having computer-readable code stored thereon, the computer readable code, when executed by a least one processor, cause performance of at least:
receiving a request to create a virtual communication channel between the real world and a virtual reality environment, the virtual reality environment comprising both audio and visual content;
in response to receiving the request, causing a virtual window to be displayed in the virtual reality environment; and
causing distorted audio from real world surroundings of a user making the request to emanate from the virtual window.

### BRIEF DESCRIPTION OF THE FIGURES

For a more complete understanding of the methods, apparatuses and computer-readable instructions described herein, reference is now made to the following description taken in connection with the accompanying figures in which:

FIG. 1 is a simplified schematic of a first example of a virtual reality system;

FIG. 2 is a simplified schematic of a second example of a virtual reality system;

FIG. 3 is a schematic illustration of components of a virtual reality content providing device;

FIG. 4 is another schematic illustration of the virtual reality content providing device of FIG. 3 incorporated into a larger system;

FIG. 5 is a flow chart illustrating operation of the virtual reality content providing device;

FIG. 6 is a flow chart illustrating operation of the virtual reality content providing device and other parts of the extended system; and

FIGS. 7a and 7b illustrates an exemplary instance of use of the system.

### DETAILED DESCRIPTION

In the description and drawings, like reference numerals may refer to like elements throughout.

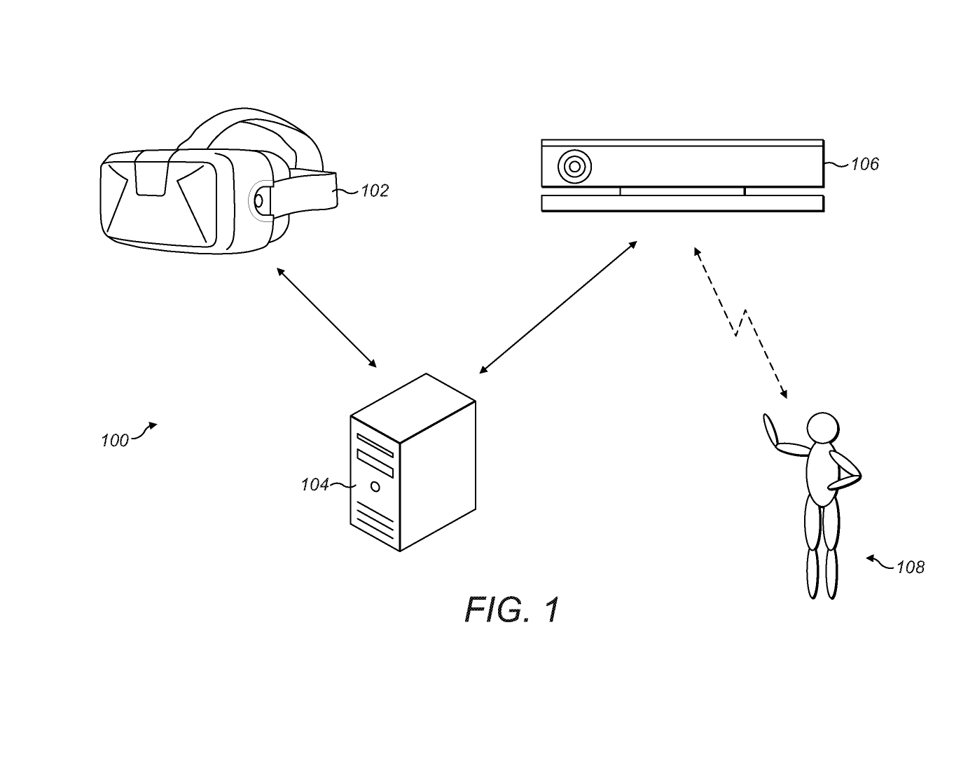

FIG. 1 is a simplified schematic of a first example of a virtual reality system 100. The first system 100 comprises a virtual reality content rendering device 102. The virtual reality content rendering device 102 may be a head mounted display or pair of glasses. An example of such a device currently available is the Oculus Rift headset, developed by Oculus VR, LLC. The virtual reality content rendering device 102 may furthermore comprise headphones which may be integral with or separate from the head mounted display. The headphones may be capable of providing spatialized audio. The content (video and audio) presented by the virtual reality content rendering device 102 may be referred to herein as a virtual reality environment. The content may be 360 degree video content captured, for example, by OZO. Alternatively the content may be a 360 degree virtual reality movie or game. A user experiencing the virtual reality environment provided by the virtual reality content rendering device 102 may be referred to herein as an immersed user. The virtual reality content rendering device 102 may furthermore comprise a forward facing optical camera (not shown) for capturing images of the real world in front of the device 102.

The first system 100 also comprises a virtual reality content providing device 104. The virtual reality content providing device 104 may be a computer such as a desktop or laptop PC or a tablet computer. The virtual reality content providing device 104 may alternatively be a video player such as a DVD or Blu-ray player. The virtual reality content providing device 104 could also be a console computer or other computing device specifically designed for use with the virtual reality content rendering device 102. The virtual reality content providing device 104 may have a wired or wireless link to the virtual reality content providing device 104 for exchanging information between these components.

The system 100 may comprise further peripheral devices (not shown) with which the immersed user may interact. These may include one or more hand held controllers, a keyboard, mouse, trackball or microphone. These peripherals may be controlled by the immersed user to interact with the virtual reality content. The peripheral devices may communicate directly with the virtual reality content rendering device 102 or directly with the virtual reality content providing device 104, or both.

The first system 100 further comprises a sensor device 106. The sensor device 106 may be a depth sensor or stereo camera for example. In some examples, the sensor device 106 is a depth sensor using infrared projection and an infrared camera to sense the motion of nearby objects in three dimensions. In some other examples, the sensor device 106 may emit infrared light in predetermined pattern and a peripheral controller (not shown) may detect this light and determine its position in three dimensions. The peripheral controller may feed its position back to the sensor device 106 or directly to the virtual reality content providing device 104 via a wireless link In some other examples, the sensor device 106 comprises a stereo camera comprising two or more optical axis for capturing two or more images from different positions. Software running of the sensor device 106 or on the virtual reality content providing device 104 may compare the multiple captured images and calculate the depth of the different parts of the images.

The sensor device 106 is configured to communicate with the virtual reality content providing device 104 over a wired or wireless data connection. In the first system 100, the sensor device 106 and the virtual reality content providing device 104 are co-located, i.e. they occupy the same general physical space or room. Therefore, the sensor device 106 is co-located with the virtual reality content rendering device 102 and immersed user. Software for interpreting the signals produced by the sensor device 106 is stored and runs on the virtual reality content providing device 104.

A second user 108 is co-located with the sensor device 106. The second user 108 may be referred to herein as the “real world user 108” to distinguish them from the “immersed user” consuming the virtual reality content. The sensor device 106 is configured to detect gestures made by the second user 108. The sensor device 106 sends signals associated with the gestures to the virtual reality content providing device 104 which runs software for interpreting these gestures.

The sensor device 106 may also be configured to detect gestures made by the immersed user, and these gestures may be a form of input for interacting with the virtual reality content.

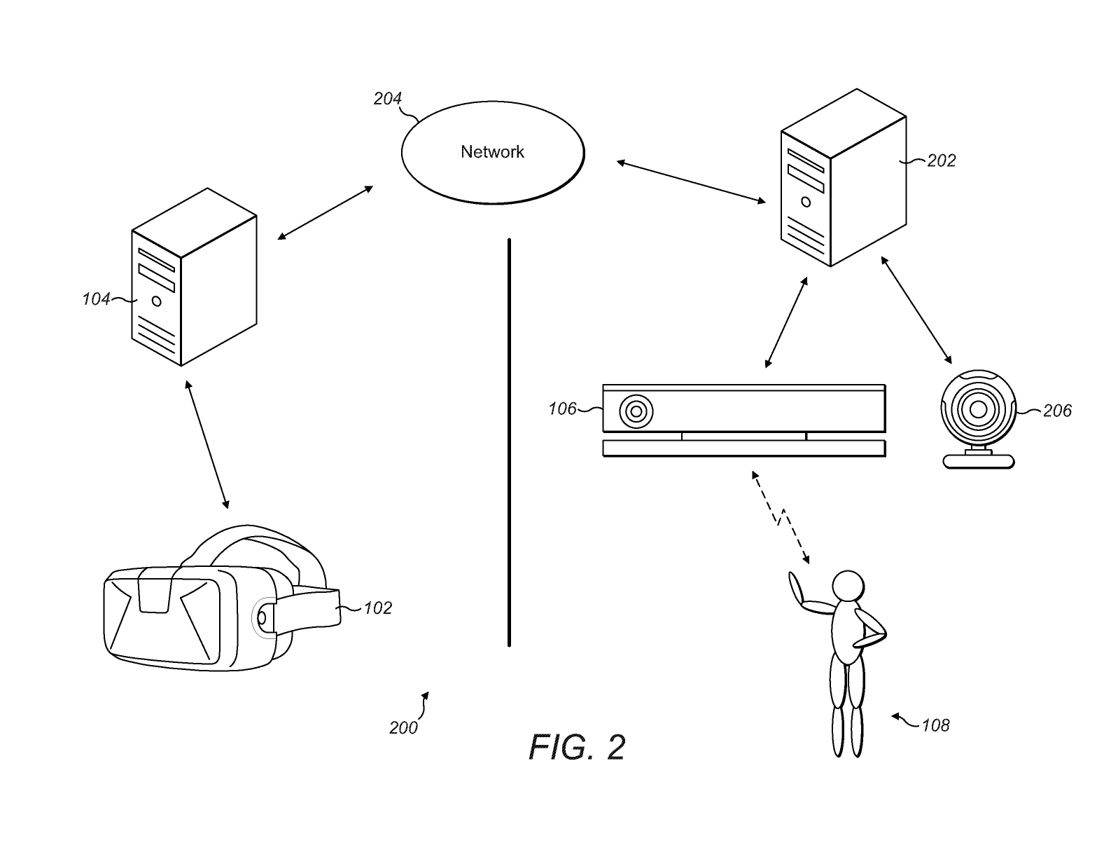

FIG. 2 is a simplified schematic of a second example of a virtual reality system 200. The second system 200 comprises the virtual reality content rendering device 102 and virtual reality content providing device 104 as in the first system 100. These components are not described in detail again here. In the second system 200, the second user 108 and the sensor device 106 are located in a different space from the virtual reality content providing device 104 and the immersed user.

The second system 200 further comprises a computer 202 configured to communicate with the sensor device 106. The computer 202 and sensor device 106 are co-located. The computer 202 and sensor device 106 may communicate over a wired or wireless data link Software for interpreting the signals produced by the sensor device 106 is stored and runs on the computer 202.

Information regarding the gestures made by the second user 108 is sent by the computer 202 to the virtual reality content providing device 104 via a network 204. The network 204 may be any suitable wired or wireless network or combination thereof, such as the internet, a LAN or WAN or a cellular network. In the second system 200, the immersed user and real world user 108 are not in the same physical space, but the virtual reality content providing device 104 can receive signals indicating gestures made by the real world user 108.

The second system 200 may also comprise one or more optical cameras 206. The one or more optical cameras 206 may be configured to capture still or moving images of the second user 108 on command and to transmit these via the computer 202 and network 204, to the virtual reality content providing device 104 for presentation within the virtual reality environment. The optical camera 206 may also retain a microphone, or a microphone may be provided separately. The microphone records and transmits audio from the surrounds of the second user 108, which may include the user's voice.

The second system 200 may also comprise a separate sensor device (not shown) for detecting gestures made by the immersed user. These gestures may be a form of input for interacting with the virtual reality content. The separate sensor device may be a depth sensor or stereo camera, similar to sensor device 106.

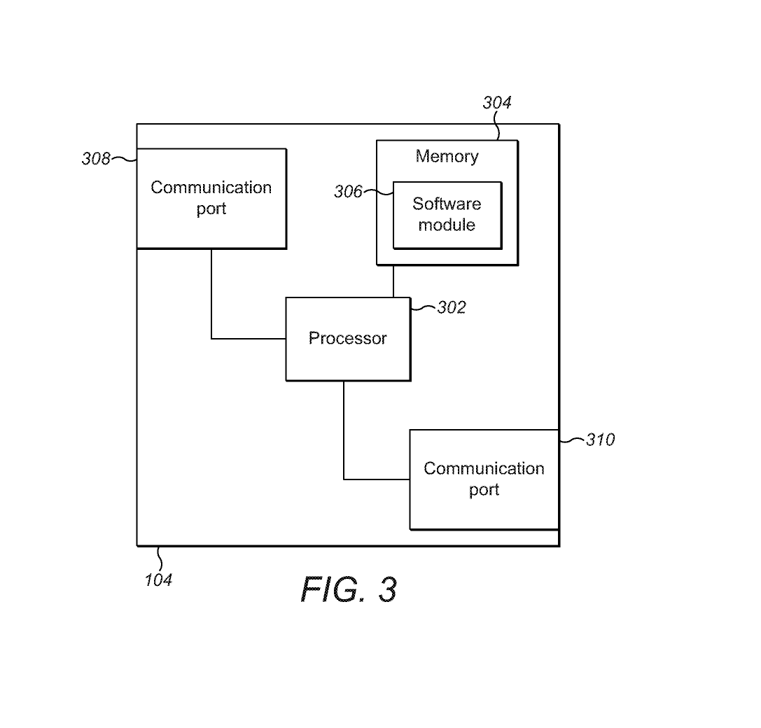

FIG. 3 is a schematic illustration of components of the virtual reality content providing device 104. The device 104 comprises a processor 302 for executing software and controlling various operations of the device 104. The device 104 comprises at least one memory 304. The memory 304 may be a writable memory such as a magnetic hard drive or flash memory. The memory 304 may store an operating system (not shown) for controlling general operation of the device 104 in conjunction with the processor 302. The memory 304 also stores a software module 306 relating to the virtual reality content.

The virtual reality content providing device 104 has a first communication port 308 and a second communication port 310. The first communication port 308 is used to exchange data with the virtual reality content rendering device 102. This includes sending video and audio data to the virtual reality content rendering device 102 and receiving movement and positioning data back from the device 102. The second communication port 310 is used to exchange data with the sensor device 106 or the computer 202, via the network 204. In embodiments where the immersed user and real world user 108 are co-located, the second communication port 310 may connect directly with the sensor device 106 for receiving gesture information. In embodiments where the immersed user and real world user 108 are not co-located, the second communication port 310 may connect to the network and receive information regarding the second user's gestures from the computer 202.

The software module 306 may comprise instructions for interpreting the signals received from the sensor device 106. For example, the software module 306 may be able to determine a number of different types of gestures based on the information received and to treat the different types of gestures as different user inputs respectively. In particular, the software module 306 may be programmed to recognise when the real world user 108 has moved their hands so as to describe all or part of a quadrilateral. For example, the software module 306 may recognise when the real world user 108 moves their hands so as to describe a square or rectangle. The software module 306 may determine that the user 108 has described a quadrilateral if it is detected that the user has described a straight line terminating at each end with a turn (in the same direction) of approximately 90 degrees, i.e. an approximate description of three connected sides of a quadrilateral.

The software module 306 is programmed to interpret the detection of the real world user 108 describing all of part of a quadrilateral as a request from the real world user 108 to open a communication channel with the immersed user. In response to detecting this request, the software module 306 is programmed to cause a virtual window to be displayed over the virtual reality content which is currently being displayed to the immersed user via the virtual reality content rendering device 102. The virtual window may appear to have a predetermined size in the virtual reality environment and/or may appear at a predetermined distance from the viewer in the virtual reality environment.

The virtual window may have the appearance of a real window. For example, the virtual window may appear to be a transparent or semi transparent pane of glass, with a solid border. Alternatively, the window may be opaque. Optionally the window may be quartered or otherwise atheistically more complicated to make it clearer to the immersed user that the virtual window is simulating a real window. The virtual window may have visible hinges and/or a handle to show that it can be opened in the virtual reality environment. The virtual window may be a quadrilateral such as a rectangle. In some other embodiments, the window may be round, oval or any other suitable regular shape. The gestural input detected as the request for opening the communication channel may have a corresponding shape. For example if the window is round the shape described by the real world user may be a circle. Correspondingly, the size of the window may correspond to the size of the shape described by the real world user.

The software module 306 is also programmed to receive audio data from the surroundings of the real world user 108 who requested the communication channel and to process this audio data to produce a distorted audio signal. The software module 306 then causes this distorted audio signal to be played in the virtual reality environment such that the distorted audio appears to emanate from the virtual window. The distorted audio may simulate the effect of the real world audio emanating from behind a physical pane of glass.

Processing the real world audio to produce the distorted audio may comprise applying a low pass filter to cut of frequencies above a predetermined threshold and/or applying an impulse response function corresponding to a pane of glass.

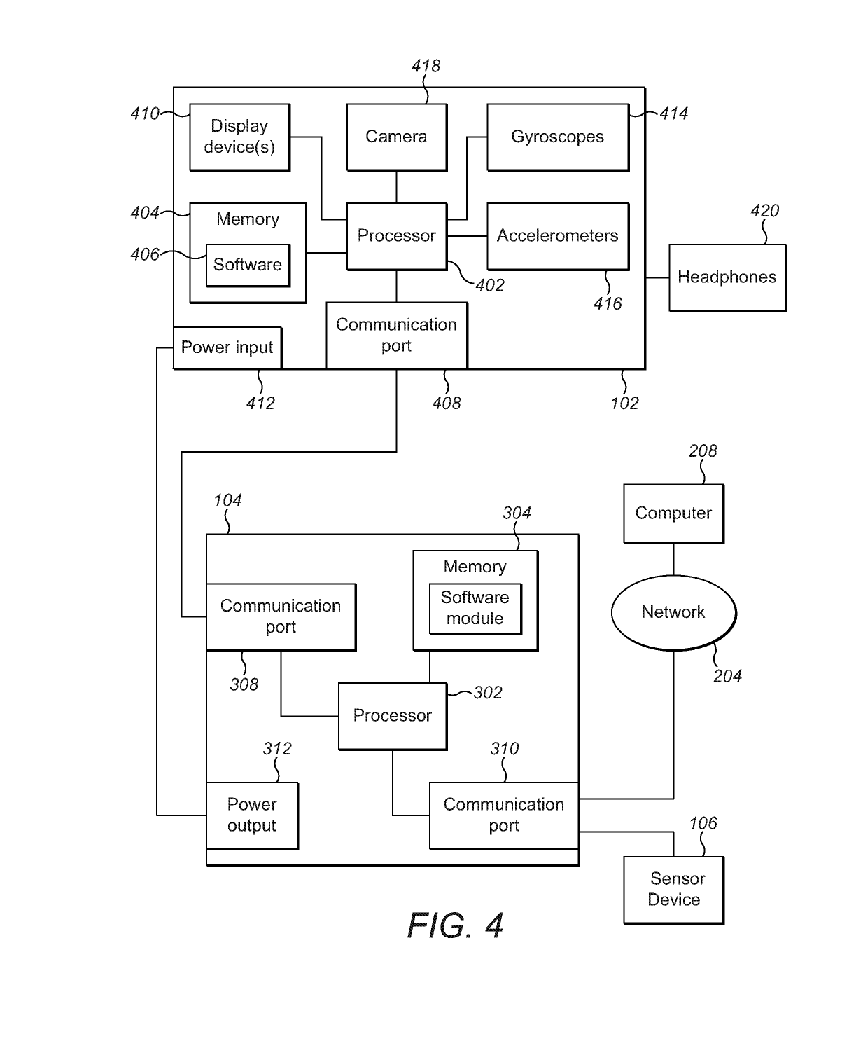

FIG. 4 is another schematic illustration of the virtual reality content providing device 104 of FIG. 3 incorporated into a larger system. The system comprises the virtual reality content rendering device 102, depth sensor 106, network 204 and computer 202 shown in FIGS. 1 and 2.

The features of the virtual reality content providing device 104 are the same as those described with reference to FIG. 3 and are not described in detail again here. The virtual reality content providing device 104 communicates with the sensor device 106 and with the computer 202 via the network 204 using the second communication port 310. Alternatively, the virtual reality content providing device 104 may comprise an additional communication port for communication via the network 204. In embodiments where these is no external computer 202 involved (see FIG. 1), the second communication port 310 is used to communicate with the sensor device 106 only.

The virtual reality content rendering device 102 comprises its own processor 402 and memory 404 storing software 406. The virtual reality content rendering device 102 has a communication port 408 for exchanging data with the virtual reality content providing device 104. The virtual reality content rendering device 102 has one or more display devices 410 for displaying the virtual reality environment to the immersed user and a power input port 412. The software 406 may for example comprise display drivers for controlling the display device 410. The virtual reality content providing device 104 may comprise a corresponding power output port 312 for supplying power to the virtual reality content rendering device 102.

The virtual reality content rendering device 102 also optionally comprises one or more gyroscopes 414, one or more accelerometers 416 and one or more cameras 418. The gyroscopes 414 and accelerometers 416 allow the virtual reality content rendering device 102 to report its position and aspect to the software 406. The camera 418 may be a forward facing camera for capturing images of the real world in front of the virtual reality content rendering device 102.

The system of FIG. 4 comprises headphones 420 for rendering virtual reality audio to the immersed user. The headphones 420 may be integral with the virtual reality content rendering device 102 or a separate device. The headphones 420 are capable of producing spatialized audio output.

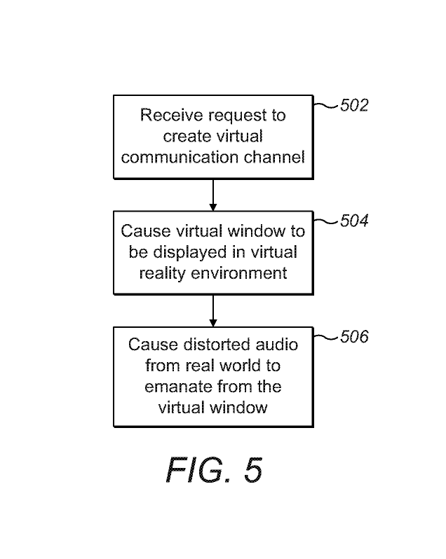

FIG. 5 is a flow chart illustrating operation of the virtual reality content providing device 104. At step 502, the virtual reality content providing device 104 receives a request to create a virtual communication channel between the real world and the virtual reality environment. The virtual reality environment comprises both audio and visual content and is rendered by the virtual reality content rendering device 102. As described above, the request may be in the form of signals indicative of a gesture performed by a user in the real world and the virtual reality content providing device 104 may be configured to interpret these signals to determine that the request is being made.

Steps 504 and 506 occur in response to step 502. At step 504, the virtual reality content providing device 104 causes a virtual window to be displayed in the virtual reality environment. As previously described, this virtual window may have the appearance of a real window and is displayed “on top” of the virtual reality environment such that it is clear to the immersed user that the virtual window is not a normal part of the virtual reality content. The size and shape of the window may be dependent on the details of the gesture made by the real world user 108. Alternatively, a standardised size and shape of virtual window may be used.

In step 506, the virtual reality content providing device 104 causes distorted audio from the real world surroundings of the user making the request to emanate from the virtual window. This may be achieved by using the spatialized audio capabilities of the headphones 420.

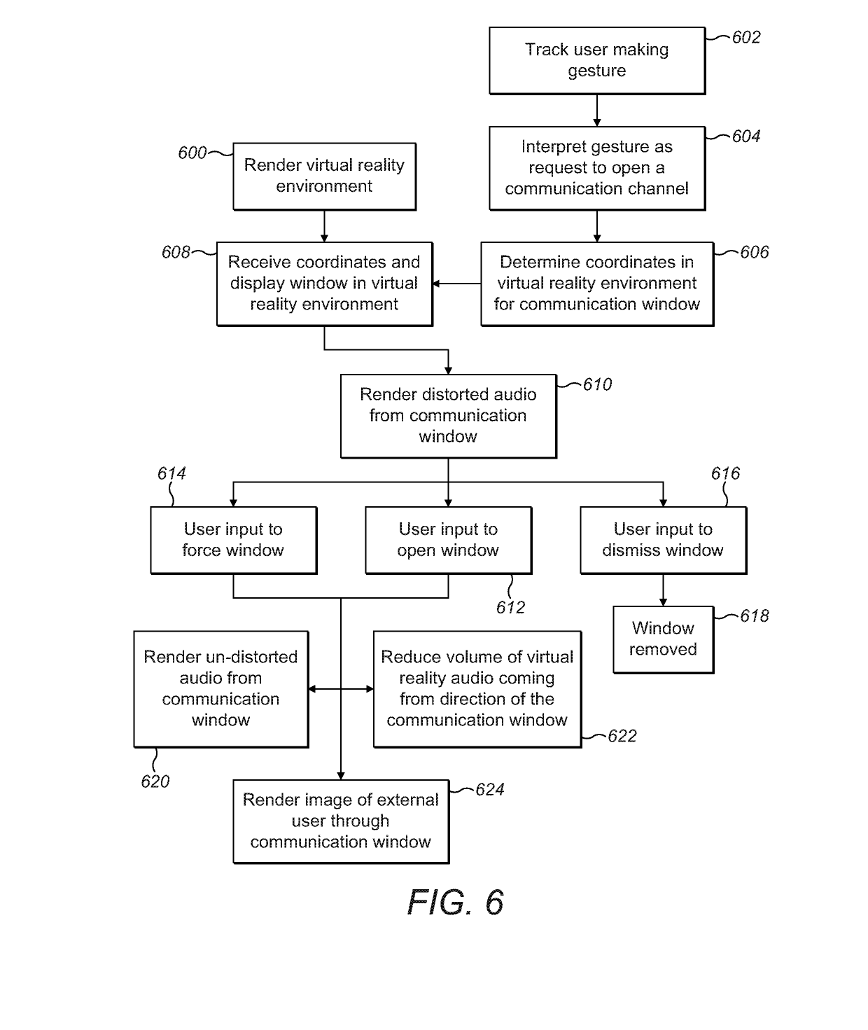

FIG. 6 is a flow chart illustrating operation of the virtual reality content providing device 104, the virtual reality content rendering device 102 and other parts of the extended system.

At step 600, the virtual reality content rendering device 102 renders a virtual reality environment. The immersed user is viewing/consuming the content presented in the environment.

At step 602, the sensor device 106 tracks a real world user making a gesture. As previously described the real world user may be in the same physical space as the immersed user, in which case the sensor device 106 may also track movements of the immersed user for the purpose of providing a form of user interaction with the virtual reality environment. The sensor device 106 sends the gesture tracking signals to the virtual reality content providing device 104. At step 604, the virtual reality content providing device 104 interprets the gesture signals as a request to open a communication channel between the real world and the virtual reality environment. At step 606, the virtual reality content providing device 104 determines the coordinates at which a window should be displayed in the virtual reality environment. Where the real world user is in the same physical space as the immersed user, this may require determining the position of the gesture relative to the position of the immersed user in the real world and mapping this to a corresponding position in the virtual world. If the real world user and the immersed user are not in the same physical space, the window may have predetermined coordinates.

In embodiments in which the real world user and the immersed user are not in the same physical space, the sensor device 106 may send the gesture tracking signals to a separate computer 202 associated with the real world user. The computer 202 may perform the steps 604 and 606, or it may simply pass the information to the virtual reality content providing device 104 via the network 204.

At step 608, the virtual reality content rendering device 102 receives the window coordinates and renders a window in the virtual reality environment. The virtual reality content rendering device 102 initially causes the window to appear closed. At step 610, the virtual reality content providing device 104 produces distorted audio which is then rendered by the headphones 420 as coming from behind the displayed window. The headphones 420 may be an integral part of the virtual reality content rendering device 102.

If the immersed user and the real world user 108 are located in the same space, then the position at which the virtual window appears in the virtual reality environment may depend on the position of the gesture made by the real world user 108 relative to the immersed user. For example, if the real world user 108 is standing to the side of the immersed user when they make the gesture, then the virtual window may be displayed to the same side of the immersed user's viewpoint in the virtual reality environment. If the immersed user and the real world user 108 are located in different spaces, then the position at which the virtual window appears in the virtual reality environment may always be the same. For example, the virtual window may appear directly in front of the immersed user in the virtual reality environment and at eye level. Alternatively, the virtual window may appear at an angle from the immersed user's current forward view, for example at 45 degrees. The virtual window may appear in a position such that the immersed user becomes aware of it, but so that it does not obstruct the user's direct view or immediately prevent the user from engaging with the virtual reality content being presented.

The virtual reality content providing device 104 may then receive a number of different inputs for determining how the communication window is treated. At step 612, the virtual reality content providing device 104 may receive a user input from the immersed user to open the window. This input may involve the immersed user turning to face the window (if the window is not already directly in front of them) and making a gesture to open the window. For example the gesture may be extending and then retracting their arm, or extending their arm and then rotating their hand. Alternatively, the user input may be provided via a hardware or software button or via a voice command

Optionally, the virtual reality content providing device 104 may have the capability to allow the real world user to force the opening of the window. This may be advantageous where the device is being used by a child and the child's parents may then have a force opening mode. Therefore, at optional step 614, the virtual reality content providing device 104 receives an input from the real world user to force the opening of the window. This input may require the real world user to make an additional gesture which is detected by the sensor device 106. The additional gesture may for example be an extension of the arm, i.e. in a pushing motion.

Optionally, the virtual reality content providing device 104 may have the capability to allow the immersed user to dismiss the window, for example if they do not wish to be disturbed at that time. Therefore, at optional step 616, the virtual reality content providing device 104 receives an input from the immersed user to dismiss the window. This input may require the immersed user to make an additional gesture which is detected by the sensor device 106. The additional gesture may for example be an extension of the arm, i.e. in a pushing motion, or a single diagonal wave of the arm. Alternatively, the immersed user may provide the dismiss window input using any other type of peripheral input device, such as a hardware button on a handheld controller. In response to receiving the user input to dismiss the window, the virtual reality content rendering device 102 removes the window from the virtual reality environment at step 618.

If the virtual reality content providing device 104 receives either of the user inputs in steps 612 or 614, then it determines that the window should be opened. The virtual reality content providing device 104 then causes steps 620, 622 and 624 to be performed. In step 620, the virtual reality content providing device 104 produces un-distorted audio which is then rendered by the headphones 420 as coming from the displayed window. The un-distorted audio may be a direct reproduction of the sound recorded from the surroundings of the real world user. The spatialized audio capabilities of the headphones 420 are employed so that the un-distorted sound appears to emanate from the location of the window. For example, the sound system may render a point sound source from the direction of the virtual window, and the content of the point source may be the mono downmix of the audio captured at the location of the real world user. This point source may be mixed to the virtual reality sound scene of the immersed user.

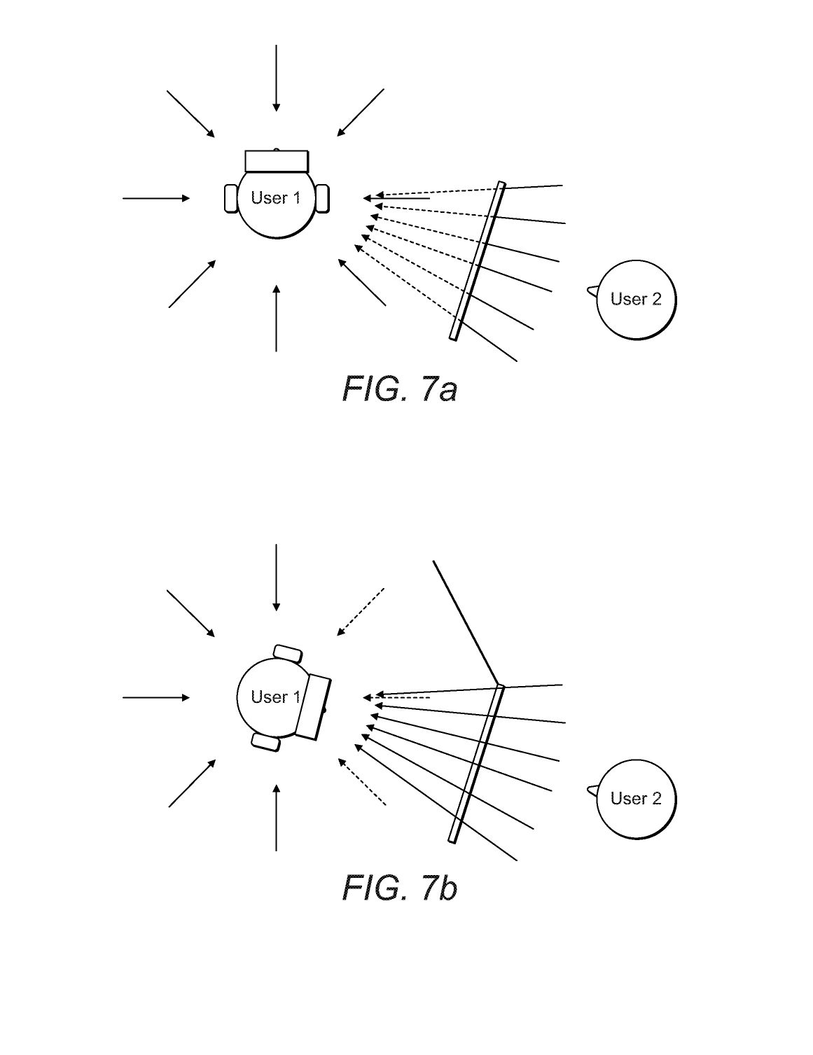

At step 622, the virtual reality content providing device 104 causes the audio components of the virtual reality environment which come from the direction of the window to be reduced in volume. The spatialized audio capabilities of the headphones 420 are employed to achieve this effect. This is advantageous as it makes it easier for the immersed user to hear the real world sounds emanating from the window, without disabling the virtual reality environment entirely. This aspect is shown in greater detail with respect to FIGS. 7a and 7b.

At step 624, the virtual reality content providing device 104 causes the virtual reality content rendering device 102 to display an image of the real world in the window. This image may be a live (e.g. video) image of the real world user captured by the front facing camera 418 of the virtual reality content rendering device 102. Step 612 may require that the user turns to face the window before it can be opened, and step 608 may require that the position of the virtual window corresponds to the position of the gesture made by the real world user. Therefore, if the immersed user and real world user are in the same space, when the immersed user turns to face the virtual window, they should be facing the real world user such that the camera 418 can record images of the real world user when the window is opened. If the immersed user and real world user are not in the same space, the image of the real world user may be recorded by a separate camera which is co-located with the real world user, and the real world user will know to position themselves in front of this camera if they wish to be seen by the immersed user. Where no camera is present (either on the virtual reality content rendering device 102 or co-located with the real world user), or if the real world user wishes only to be heard and not seen, or if the immersed user wishes only to hear and not see the real world user, then no image may be rendered in the window. Thus, step 624 is optional. If no image of the real world user is rendered in the window, a generic or background image may instead be rendered.

Referring now to FIGS. 7a and 7b, an exemplary instance of use of the system described herein is shown. FIG. 7a shows a first user, who is the immersed user. The first user is viewing virtual reality content including both audio and visual content. The virtual reality content is 360 degree content and thus the first user is presented with audio from multiple directions, as illustrated by the solid arrows in FIG. 7a.

FIG. 7a shows a second user, who is the real world user. In this example, the first and second user are located in the same space, and the second user is standing to the right and slightly behind the first user. The second user has requested the creation of a communication channel between the real world and virtual reality environment. The second user may have done this by making a predefined gesture with their body which was detected by a sensor device 106 co-located with the second user. This request results in a window being displayed in the virtual reality environment. Due to the relative positions of the first and second users, the window appears to the right and slightly behind the first user.

Sounds from the real world surroundings of the second user are detected by a microphone or similar device. The microphone may be a part of the virtual reality content rendering device 102, or of the virtual reality content providing device 104, or a separate device in communication with the virtual reality content providing device 104. The microphone may be a directional microphone. These sounds are processed by the virtual reality content providing device 104 so as to produce a distorted or muffled version of the sounds, as illustrated by the dashed arrows in FIG. 7a. The distorted sound may simulate the effect of the real world sounds coming from behind a real window, i.e. from behind a pane of glass. This may be achieved by storing in the memory 304 of the virtual reality content providing device 104 an audio impulse response function of a real pane of glass and applying this function to the detected sounds. For example, the audio impulse response function of the pane of glass may be measured by rendering sound from behind the real glass and capturing it on the other side. The filtering caused by the “transmission path” through the glass is then modelled and can be reproduced in the virtual acoustics by filtering the sound with the impulse response. A low pass filter may also be applied. For example, sounds having a frequency higher than 300 Hz (or any other suitable value) may be blocked.

Where the system features one or more directional microphones, the audio rendering system (e.g. headphones 420) for the first user may separate the sound coming from the outside into direct and ambient parts. The direct parts comprise the direct sound from different sources such as speakers or equipment. The ambient part comprises background noises without any obvious source and the reflections from the walls. The virtual reality content providing device 104 will determine those direct sounds which are coming from the direction of the virtual window towards the person in the virtual reality environment. These direct sounds are mixed with the ambient part, and this forms the audio signal of the outside environment to be rendered to the person in virtual reality environment. Before rendering, the signal is filtered with the muffling filter as described above. The final audio scene experienced by the immersed user comprises the virtual reality audio scene mixed with a virtual loudspeaker source at the position of the virtual window, which renders the outside environment audio signal.

In FIG. 7b, the first user has decided to open the communication channel. The first user may do this by turning towards the virtual window and performing a gesture as for opening a real window or in any of the other ways previously described. Alternatively, the first user may be able to open the window without turning towards it. At this point, the immersed user is able to see the outside user and to hear clean (i.e., the original, non-filtered) sound coming through that window from the real world, as indicated by the solid arrows passing through the window in FIG. 7b. In some embodiments, only direct real world sounds that come from the direction of the window are played to the person in virtual reality environment, along with the ambience signal, and they are rendered from a virtual loudspeaker at the position of the virtual window. The sound of the virtual reality content which comes from the direction of the opened window is sent to background (e.g., by lowering the volume), in order not to disturb the real-world sound coming through the window, as indicated by the dashed arrows in FIG. 7b.

Once the first and second users have concluded their communication, the first user may make a further gesture (or other input) to close the window. This further gesture may be the same as that used to open the window, or the reverse of this gesture, or a completely different gesture.

The virtual reality content rendering device 102 may then cause the window to close and to disappear.

Optionally, the virtual reality content providing device 104 may provide the capability for the immersed user to preview the real world content which would emanate form the virtual window. The immersed user may provide a different user input, which may be a different gestural input, which may cause the virtual window to be partially opened. The immersed user may be presented with un-distorted audio at a lower volume than if they were to fully open the window. The volume of the audio forming the virtual reality environment may not be reduced during the preview. The preview may be only audio or only video from the real world.

While the window is initially displayed in the closed state, it has the appearance of a real window, as previously described. Optionally, the virtual reality content rendering device 102 may at this stage already be receiving video imagery of the real world user. For example, the front facing camera 418 may begin image recording as soon as the communication request is received. The virtual reality content rendering device 102 could therefore display a blurred version of the video imagery in the virtual window, e.g. as if the image were being viewed through frosted glass.

As will be appreciated, the system and apparatuses described herein may include various components which have may not been shown in the Figures. In particular, the virtual reality content providing device 104 and virtual reality content rendering device 102 may comprise further optional software components which are not described in this specification since they may not have direct interaction to embodiments of the invention.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc, or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices and other devices. References to computer program, instructions, code etc. should be understood to express software for a programmable processor firmware such as the programmable content of a hardware device as instructions for a processor or configured or configuration settings for a fixed function device, gate array, programmable logic device, etc.

As used in this application, the term ‘circuitry’ refers to all of the following: (a) hardware-only circuit implementations (such as implementations in only analogue and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. A method comprising:
receiving a request to create a virtual communication channel between a real world and a virtual reality environment, the virtual reality environment comprising both audio and visual content;
in response to receiving the request, causing a virtual window to be displayed in the virtual reality environment; and
causing distorted audio from real world surroundings of a user making the request to emanate from the virtual window.

2. The method according to claim 1, comprising creating the distorted audio by applying an audio filter which mimics the effect of the audio emanating from behind a window pane of glass.

3. The method according to claim 2, wherein applying an audio filter comprises applying a low pass filter, applying an impulse response function corresponding to a pane of glass to audio from the real world surroundings of the user making the request, or any combination thereof.

4. The method according to claim 1, wherein receiving a request to create a virtual communication channel comprises receiving a gestural input signal.

5. Apparatus comprising:
at least one processor; and
at least one memory including computer program code, which when executed by the at least one processor, cause the apparatus:
to receive a request to create a virtual communication channel between a real world and a virtual reality environment, the virtual reality environment comprising both audio and visual content;
in response to receiving the request, to cause a virtual window to be displayed in the virtual reality environment; and
to cause distorted audio from real world surroundings of a user making the request to emanate from the virtual window.

6. The apparatus according to claim 5, wherein the computer program code, when executed by the at least one processor,
causes the apparatus to create the distorted audio by applying an audio filter which mimics the effect of the audio emanating from behind a window pane of glass.

7. The apparatus according to claim 5, wherein applying an audio filter comprises applying a low pass filter, applying an impulse response function corresponding to a pane of glass to audio from the real world surroundings of the user making the request, or any combination thereof.

8. The apparatus according to claim 5, wherein receiving a request to create a virtual communication channel comprises receiving a gestural input signal.

9. The apparatus according to claim 8, wherein the computer program code, when executed by the at least one processor, causes the apparatus to receive the gestural input signal from a depth sensing device monitoring the surroundings of the user making the request.

10. The apparatus according to claim 8, wherein the gestural input signal comprises a mid-air description of all or part of a quadrilateral.

11. The apparatus according to claim 8, wherein the computer program code, when executed by the at least one processor, causes the apparatus to determine that the gestural input comprises a request to create a window between the real world and the virtual reality environment.

12. The apparatus according to claim 5, wherein the computer program code, when executed by the at least one processor, causes the apparatus to cause the virtual window to appear as a closed window when the virtual window is initially displayed.

13. The apparatus according to claim 5, wherein the computer program code, when executed by the at least one processor, causes the apparatus to receive a first input at the virtual window from a user immersed in the virtual reality environment and, in response to receiving the first input, to cause the virtual window to change from a closed state to an open state.

14. The apparatus according to claim 13, wherein the computer program code, when executed by the at least one processor, causes the apparatus to, in response to receiving the first input at the virtual window, cause un-distorted audio from the real world surroundings of the user making the request to create the virtual communication channel to emanate from the virtual window.

15. The apparatus according to claim 13, wherein the computer program code, when executed by the at least one processor, causes the apparatus to, in response to receiving the first input at the virtual window, cause video images from the real world surroundings of the user making the request to create the virtual communication channel to be displayed in the virtual window.

16. The apparatus according to claim 13, wherein the computer program code, when executed by the at least one processor, causes the apparatus to cause the audio content of the virtual reality environment emanating from the direction of the virtual window to be attenuated when the virtual window is in the open state.

17. The apparatus according to claim 5, wherein the computer program code, when executed by the at least one processor, causes the apparatus to receive a second input from a user immersed in the virtual reality environment and, in response to receiving the second input, cause the virtual window to be removed from the virtual reality environment.

18. The apparatus according to claim 5, wherein the user immersed in the virtual reality environment and the user making the request to create a virtual communication channel between the real world and a virtual reality environment are located in the same physical space.

19. The apparatus according to claim 5, wherein the user immersed in the virtual reality environment and the user making the request to create a virtual communication channel between the real world and a virtual reality environment are located in different physical spaces.

20. A computer-readable medium having computer-readable code stored thereon, the computer readable code, when executed by a least one processor, cause performance of at least:
receiving a request to create a virtual communication channel between a real world and a virtual reality environment, the virtual reality environment comprising both audio and visual content;
in response to receiving the request, causing a virtual window to be displayed in the virtual reality environment; and
causing distorted audio from real world surroundings of a user making the request to emanate from the virtual window.
